(19) United States
(12) Patent Application Publication
(10) Pub. No.: US 2007/0193036 A1
(43) Pub. Date: Aug. 23, 2007

(54) FOLDING KNIFE WITH MAGNETIC PIECE

(75) Inventor: Kelly Carlson, Antrim, NH (US)

Correspondence Address: WALTER J, TENCZA JR., 10 STATION PLACE, SUITE 3, METUCHEN, NJ, 08840, US

(73) Assignee: MASTER CUTLERY INC., SECAUCUS, NJ (US)

(21) Appl. No.: 11/307,783

(22) Filed: Feb. 22, 2006

(51) Int. Cl. B26B 1/02

(52) U.S. Cl. 30/158; 30/155

(57) ABSTRACT

A folding knife is disclosed including a blade, a handle device, and a magnetic piece. The blade may be connected to the handle device so that the blade can pivot with respect to the handle device. The magnetic piece may be fixed to the handle device so that the magnetic piece attracts and pulls the blade into a closed position or into an open position by a magnetic attraction between the blade and the magnetic piece. The magnetic piece may be a post fixed between left and right side plates.

### FIELD OF THE INVENTION

This invention relates to improved methods and apparatus concerning folding knives.

### BACKGROUND OF THE INVENTION

There are various types of folding knives known in the art.

### SUMMARY OF THE INVENTION

One embodiment of the present invention provides a folding knife comprising a blade, a handle device, and a magnetic piece. The blade may be connected to the handle device so that the blade can pivot with respect to the handle device. The magnetic piece may be fixed to the handle device so that the magnetic piece functions as a stop for the blade in open and closed states. The magnetic piece also assists the blade into both the opening and the closing states or positions.

The blade may have first end and a second end. A point may be located at the first end and a protrusion may be located at the second end. When the folding knife is in a fully closed state, the protrusion protrudes out from the handle device while the point is located within the handle device. The protrusion can be pressed on to cause the blade to pivot into a fully opened state. The protrusion may have a plurality of ridges.

The handle device may include a first plate and a second plate. The blade may be connected between the first plate and the second plate. The magnetic piece may be a post which functions as a stop for the blade. When the folding knife is in a fully opened position or state, the protrusion of the blade may come in contact and be magnetically attracted by the magnetic piece or post. When the folding knife is in a fully closed position or state, a different portion of the blade may come in contact and be magnetically attracted by the magnetic piece or post.

A method is also disclosed comprising connecting a handle device to a blade so that the blade can pivot with respect to the handle device, and fixing a magnetic piece or post to the handle device so that the magnetic piece assists the blade into both the opening and the closing states or positions.

### BRIEF DESCRIPTION OF THE DRAWINGS

FIG. 1 shows a bottom perspective view of a folding knife in accordance with an embodiment of the present invention, with the folding knife shown in a fully opened state;

FIG. 2 shows a top perspective view of the folding knife of FIG. 1, with the folding knife shown in a fully opened state;

FIG. 3 shows a right side view of the folding knife of FIG. 1, with the folding knife shown in a fully opened state, and with part of the blade which is inside a handle device and a magnetic piece or post shown in dashed lines;

FIG. 4 shows a left side view of the folding knife of FIG. 1, with the folding knife shown in a fully opened state;

FIG. 5 shows a right side view of the folding knife of FIG. 1, with the folding knife shown in a fully closed state;

FIG. 6 shows a left side view of the folding knife of FIG. 1, with the folding knife shown in a fully closed state;

FIG. 7 shows a top view of the folding knife of FIG. 1, with the folding knife shown in a fully opened state;

FIG. 8 shows a bottom view of the folding knife of FIG. 1, with the folding knife shown in a fully opened state;

FIG. 9 shows a right side view of a blade for use with the folding knife of FIG. 1;

FIG. 10 shows a left side view of the blade of FIG. 9;

FIG. 11 shows a left side view of a spacer for use with the folding knife of FIG. 1;

FIG. 12 shows a right side view of the spacer of FIG. 12;

FIG. 13 shows a left side view of the folding knife of FIG. 1, with the folding knife shown in a fully closed state and with the spacer, the magnetic piece or post and the blade, shown in dashed lines;

FIG. 14 shows a view of an inner surface of a right side plate of the folding knife of FIG. 1; and

FIG. 15 shows a view of an inner surface of a left side plate of the folding knife of FIG. 1.

### DETAILED DESCRIPTION OF THE DRAWINGS

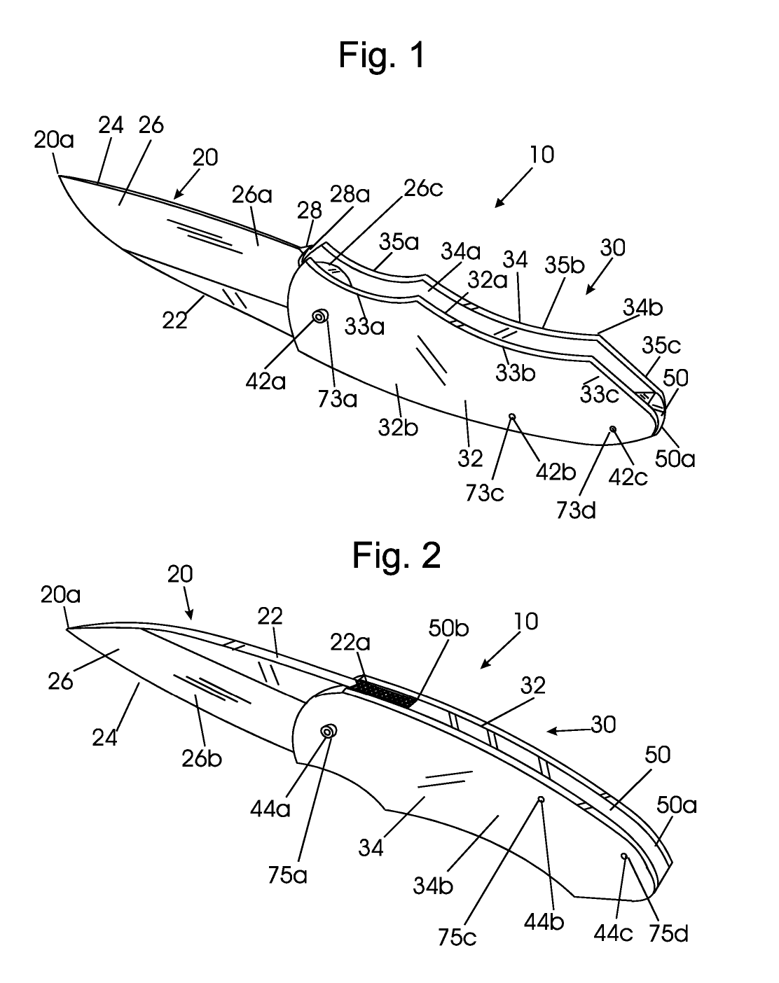

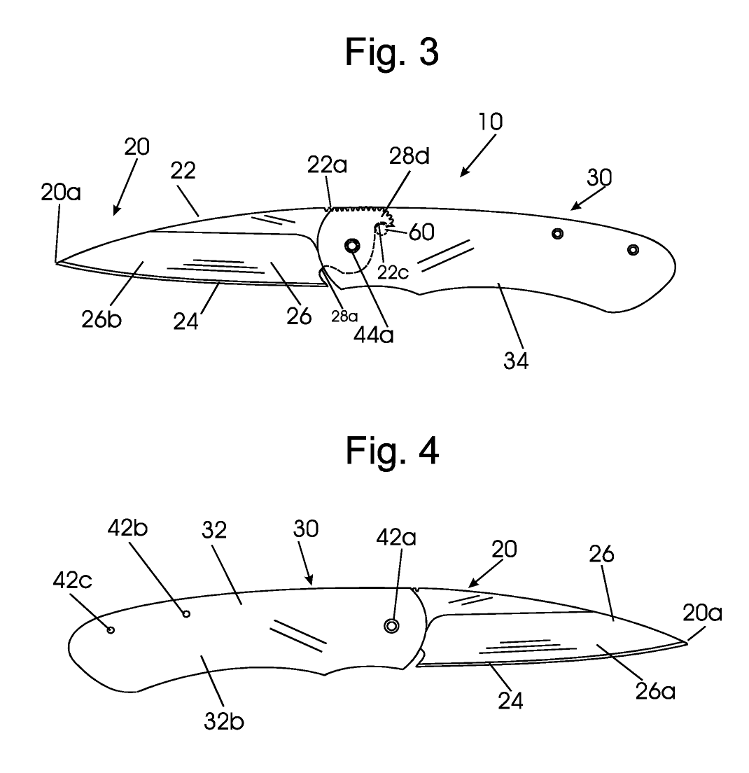

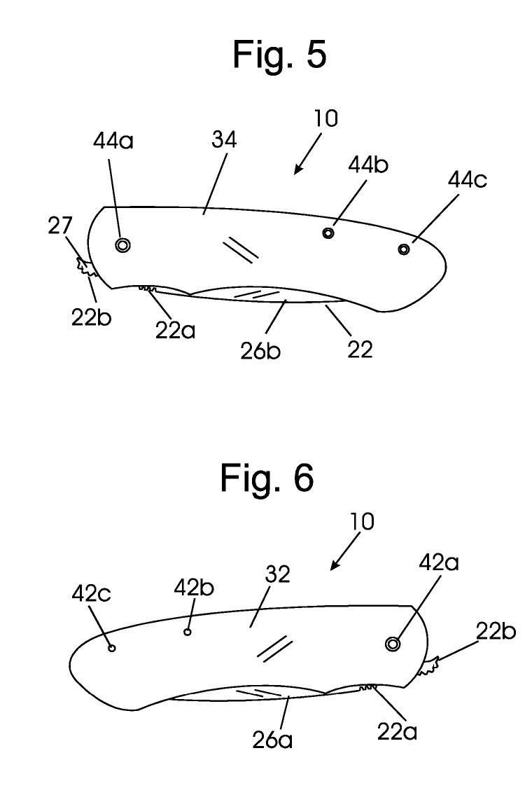

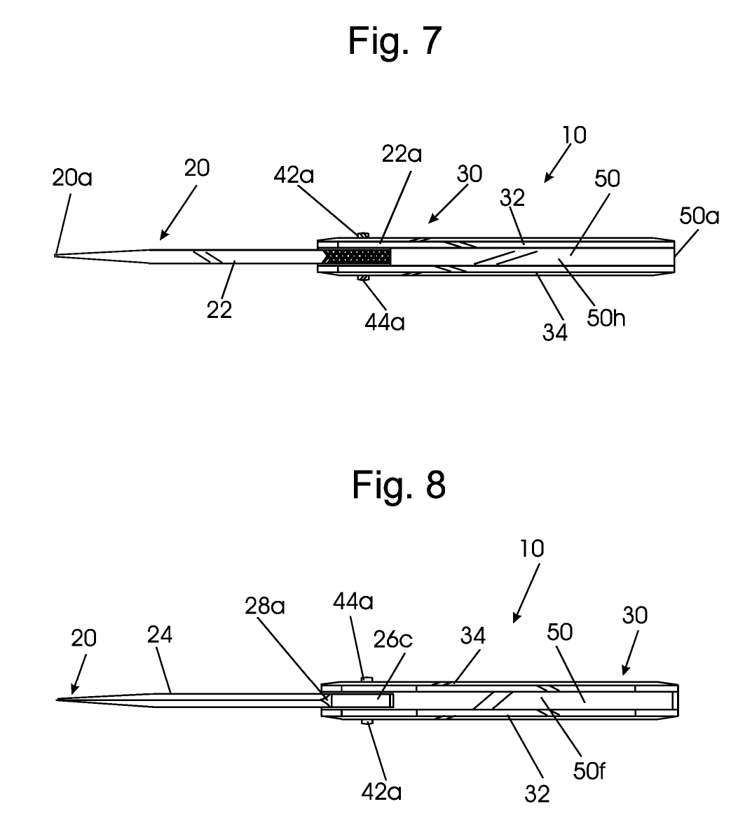

FIG. 1 shows a bottom perspective view of a folding knife 10 in accordance with an embodiment of the present invention, with the folding knife 10 shown in a fully opened state. FIG. 2 shows a top perspective view of the folding knife 10 of FIG. 1, with the folding knife 10 shown in a fully opened state. FIGS. 3 and 4 show right and left side views, respectively, of the folding knife 10, with the folding knife 10 shown in a fully opened state. FIG. 3 also shows, in dashed lines, a portion of a blade 20 of the folding knife 10 and a magnetic post or piece 60, which are located inside of a handle device 30. FIGS. 5 and 6 show right and left side views, respectively, of the folding knife 10, with the folding knife 10 shown in a fully closed state. FIGS. 7 and 8 show top and bottom views, respectively, of the folding knife 10, with the folding knife 10 shown in a fully opened state.

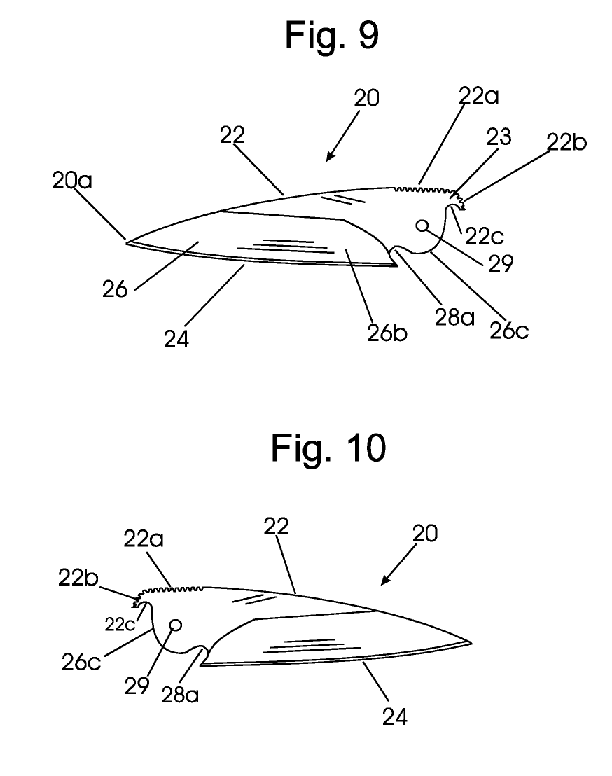

Referring to FIGS. 1-8, the folding knife 10 includes blade 20, and handle device 30. FIGS. 9-10 shows right and left side views, respectively, of the blade 20 for use with the folding knife 10 of FIG. 1. The blade 20 includes top surface 22, bottom sharp edge 24, and body portion 26. The body portion 26 has a left side surface 26a and a right side surface 26b, shown in FIGS. 1 and 2, respectively. The blade 20 has a sharp pointed end 20a and a triangular shaped end 28. The blade 20 has an arced or curved indentation 28a, shown in FIGS. 9 and 10. The blade 20 also includes ridges 22a and 22b, a curved or arced edge or indentation 22c, and a curved section 26c. The ridges 22a may be substantially perpendicular to the ridges 22b. The blade 20 has a hole 29. The blade 20 may be made of stainless steel. The blade 20 may include protrusion or “flipper” protrusion 23. The flipper protrusion 23 facilitates placing the blade 20 in an open position. This same function can be served by a blade mounted thumb stud or hole in the blade 20.

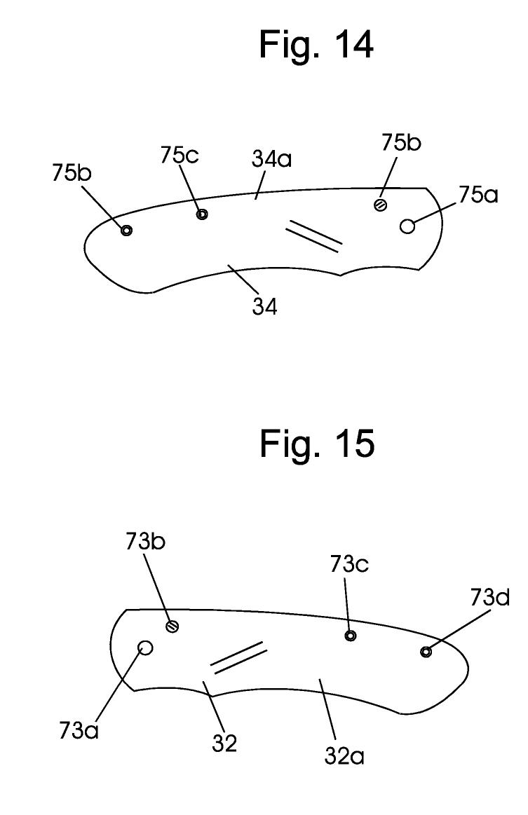

The handle device 30 includes a left side plate 32 and a right side plate 34 shown in FIGS. 1 and 2, respectively. The left side plate 32 includes an outer surface 32b, and openings 73a, 73c, and 73d, as shown by FIGS. 1 and 15. The left side plate also includes an inner surface 32a and an indentation 73b as shown in FIG. 15. The right side plate 34 includes an outer surface 34b, and openings 75a, 75c, and 75d, as shown by FIGS. 2 and 14. The right side plate also includes an inner surface 34a and an indentation 75b as shown in FIG. 14. The left side plate 32 and the right side plate 34 may be made of plastic ??. The left side plate 32 may include curved edges 33a, 33b, and 33c. The right side plate 34 may include curved edges 35a, 35b, and 35c.

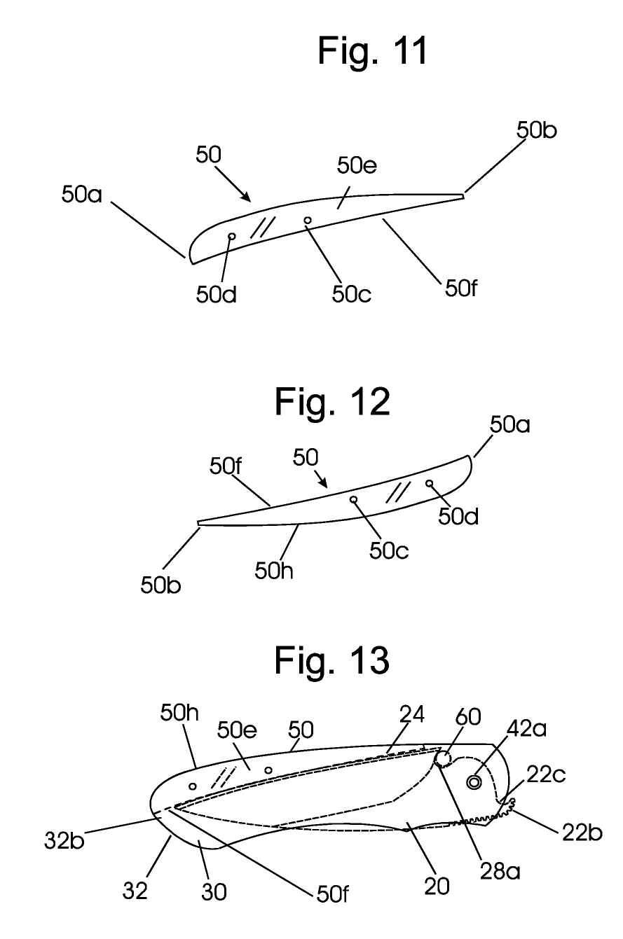

The handle device 30 also includes a spacer or spacer piece or device 50 as shown by FIGS. 1, 2, 7, 8, and 11-13. The spacer 50 has an end 50a and an end 50b as shown in FIG. 2. The spacer has a top curved surface 50h, a bottom curved surface 50f, a right side surface 50e, and a left side surface 50g, as shown in FIGS. 11-12. The spacer 50 also has openings 50c and 50d. The spacer 50 may be solid and may be made of rubber ??.

The blade 20 is connected to the handle device 30 by inserting a pin 44a into opening 75a of the right side plate 34, through the opening 29 of the blade 20, and finally through the opening 73a of the left side plate 32. The pin 44a may be connected to an attachment device 42a which may be a nut or any other attachment device. The pin 44a may be a screw or any type of pin.

The right side plate 34 is further attached to the left side plate 32 by inserting pins 44b and 44c through openings 75c and 75d, then through openings 50c and 50d of spacer 50, and finally through openings 73c and 73d, respectively. The pins 42b and 42c may be the same as the pins 44b and 44c with the indentifiers 42b and 42c identifying one side of the pins and the identifiers 44b and 44c identifying the other side of the pins.

The folding knife 10 also includes the magnetic piece 60, whose location is shown by dashed lines in FIGS. 3 and 13. The magnetic piece 60 prevents the blade 20 from opening further than the position shown in FIG. 3 and prevents the blade 20 from closing further than the position shown in FIG. 13. The magnetic piece 60 also assist the blade 20 in opening or closing by magnetically attracting a portion of the blade 20. For opening, the magnetic piece 60 magnetically attracts the curved section or edge 22c of the blade 20 as shown in FIG. 3. The curved section 22c may be semi-circular so as to provide fuller contact with the typically cylindrical magnetic piece or post 60. When the blade 20 is in a fully opened position, as in FIG. 3, the edge 22c of the blade 20 is in contact with the magnetic piece or post 60. For closing, the magnetic piece 60 magnetically attracts the curved section or edge 28a of the blade 20 shown by dashed lines in FIG. 13. When the blade 20 is in a fully closed position, as in FIG. 13, the edge 28a of the blade 20 is in contact with the magnetic piece or post 60. The curved section 28a may be semi-circular so as to provide fuller contact with the typically cylindrical magnetic piece or post 60. The magnetic piece 60 may be a powerful neodymium magnet. The magnetic piece or post may be fixed between the plates 32 and 34 of the handle device 30. The magnetic piece or post 60 may be a solid cylinder having a first end sitting in or connected to the indentation 75b of plate 34 and a second end sitting in or connected to the indentation 73b of the plate 32.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. A folding knife comprising:
a blade;
a handle device; and
a magnetic piece;
wherein the blade is connected to the handle device so that the blade can pivot with respect to the handle device; and
wherein the magnetic piece is fixed to the handle device so that the magnetic piece attracts and pulls the blade into a closed position by a magnetic attraction between the blade and the magnetic piece.

2. The apparatus of claim 1 wherein
the magnetic piece is fixed to the handle device so that the magnetic piece attracts and pulls the blade into an open position by a magnetic attraction between the blade and the magnetic piece.

3. The apparatus of claim 1 wherein
the handle device is comprised of a left side plate and a right side plate;
and wherein the magnetic piece is a post which is fixed between the left side plate and the right side plate.

4. The apparatus of claim 3 wherein
the blade is comprised of a first curved edge and an attraction between the first curved edge and the magnetic piece pulls the blade into a closed position.

5. The apparatus of claim 2 wherein
the handle device is comprised of a left side plate and a right side plate;
and wherein the magnetic piece is a post which is fixed between the left side plate and the right side plate.

6. The apparatus of claim 5 wherein
the blade is comprised of a first curved edge and an attraction between the first curved edge and the magnetic piece pulls the blade into a closed position; and
the blade is comprised of a second curved edge and an attraction between the second curved edge and the magnetic piece pulls the blade into an open position.

7. The folding knife of claim 1 wherein
the blade has a first end and a second end;
wherein a point is located at the first end and a protrusion is located at the second end;
wherein when the folding knife is in a fully closed state, the protrusion protrudes out from the handle device while the point is located within the handle device; and
wherein the protrusion can be pressed on to cause the blade to pivot into a fully opened state.

8. The folding knife of claim 1 wherein
the handle device includes a first plate and a second plate;
and wherein the blade is connected between the first plate and the second plate.

9. The folding knife of claim 7 wherein
the protrusion has a plurality of ridges.

10. A method comprising the steps of
connecting a handle device to a blade so that the blade can pivot with respect to the handle device; and
fixing a magnetic piece to the handle device so that the magnetic piece attracts and pulls the blade into a closed position by a magnetic attraction between the blade and the magnetic piece.

11. The method of claim 10 wherein
the magnetic piece is fixed to the handle device so that the magnetic piece attracts and pulls the blade into an open position by a magnetic attraction between the blade and the magnetic piece.

12. The method of claim 10 wherein
the handle device is comprised of a left side plate and a right side plate;
and wherein the magnetic piece is a post which is fixed between the left side plate and the right side plate.

13. The method of claim 12 wherein
the blade is comprised of a first curved edge and an attraction between the first curved edge and the magnetic piece pulls the blade into a closed position.

14. The method of claim 11 wherein
the handle device is comprised of a left side plate and a right side plate;
and wherein the magnetic piece is a post which is fixed between the left side plate and the right side plate.

15. The method of claim 14 wherein
the blade is comprised of a first curved edge and an attraction between the first curved edge and the magnetic piece pulls the blade into a closed position; and
the blade is comprised of a second curved edge and an attraction between the second curved edge and the magnetic piece pulls the blade into an open position.

16. The method of claim 10 wherein
the blade has a first end and a second end;
wherein a point is located at the first end and a protrusion is located at the second end;
wherein when the folding knife is in a fully closed state, the protrusion protrudes out from the handle device while the point is located within the handle device; and
wherein the protrusion can be pressed on to cause the blade to pivot into a fully opened state.

17. The method claim 10 wherein
the handle device includes a first plate and a second plate;
and wherein the blade is connected between the first plate and the second plate.

18. The method of claim 17 wherein
the protrusion has a plurality of ridges.
